(19) United States
(12) Patent Application Publication
(10) Pub. No.: US 2003/0220411 A1
(43) Pub. Date: Nov. 27, 2003

(54) Extruded product of foamed rubber

(76) Inventors: Takaaki Sakai, Nishikasugai-gun (JP); Tomoaki Okita, Nishikasugai-gun (JP)

Correspondence Address: POSZ & BETHARDS, PLC, 11250 ROGER BACON DRIVE, SUITE 10, RESTON, VA, 20190, US

(21) Appl. No.: 10/438,933

(22) Filed: May 16, 2003

(30) Foreign Application Priority Data
May 17, 2002 (JP) P2002-143361

(51) Int. Cl. B29C 44/02; C08L 23/00

(52) U.S. Cl. 521/134; 264/54; 521/142

(57) ABSTRACT

The invention is to provide an extruded product of a foamed rubber satisfying requisite features as to the abrasion resistance or the surface skin in the glass run, while maintaining the foaming magnification enabling to reply the demands of the weight lightening. An ethylene-α-olefin based rubber is substantially a raw rubber, and is extruded from a compounded material of the foamed rubber prepared (vulcanized material) with a thermal decomposition typed foaming agent. This extruded product of the foamed rubber has physical properties of foaming magnification: 1.05 to 1.55, bubble diameter: 110 μm or less, and thickness of skin layer: 130 μm or more.

The present application is based on Japanese Patent Application No. 2002-143361, the entire contents of which are incorporated herein by reference.

### BACKGROUND OF THE INVENTION

1. Field of the Invention

The present invention relates to an extruded product of a foamed rubber (vulcanized material), and a method of producing the same, wherein an ethylene-α-olefin based rubber is substantially a raw rubber, and extruded from a compounded material of a foamed rubber prepared with a thermal decomposition typed foaming agent.

2. Description of the Related Art

Herein, as the compounded material of the foamed rubber, explanation will be made to a weather strip for automobiles such as a glass run (single channel type) as shown in FIG. 1, but no limitation is specified thereto.

The illustrated glass run main body 10 includes a pair of seal lips 12, 12 to which a glass G contacts and slides at both sides, and a cross section of a single channel having a bottom part 14 to which the glass G contacts and slides at its end face. The glass contact-sliding portions of the seal lips 12 and the bottom part 14 are formed with a coated sliding film 16 of urethane paint.

The glass run main body 10 has employed the vulcanized material of the extruded rubber being a solid compounded material of the ethylene-α-olefin based rubber (EOR) represented by EPDM, but for satisfying a recent demand of lightening weight to the glass run, it is assumed to extrude and form the rubber compounded material through finely foaming preparation and serve it as it is.

However, as to the extrusion-formed rubber vulcanized material from the rubber compounded material of the ordinary finely foaming preparation (foaming magnification: 1.05 to 1.5), problems are easy to occur about abrasion resistance or a surface skin, and it has been difficult to reduce extruded vulcanized materials in products as they are.

Lowering the foaming magnification, the above problems are solved to a certain extent, but it is difficult to satisfy the demand of lightening weight.

### SUMMARY OF THE INVENTION

In view of the above mentioned circumstances, it is an object of the invention to provide an extruded product of a foamed rubber satisfying requisite features as to the abrasion resistance or the surface skin in the glass run, while maintaining the foaming magnification enabling to reply the demands of the weight lightening.

For accomplishing the above object, in the course of making studies on developments of the invention, having found to reduce average bubble diameters (briefly called as “bubble diameter” hereafter) under a predetermined value and to increase average thickness of the skin layer (briefly called as “thickness of the skin layer” hereafter) above a predetermined value, the invention has come to the extruded product of the foamed rubber of an under mentioned structure.

The extruded product of the foamed rubber (vulcanized material), where the ethylene-α-olefin based rubber is substantially the raw rubber, and is extruded from the compounded material of the foamed rubber prepared with the thermal decomposition typed foaming agent, and is characterized by the foaming magnification: 1.05 to 1.55, the bubble diameter: 110 μm or less, and the thickness of the skin layer: 130 μm or more.

In other words, making the foaming magnification enable to lighten the weight of the rubber vulcanized material, the bubble diameter under the predetermined value, and the thickness of the skin layer above the predetermined value, it is possible to easily satisfy the abrasion resistance and the surface skin of the rubber vulcanized material, and the requisite features in such as the glass run.

In the glass run, it is desirable that as to, e.g., the abrasion resistance, repetition of wearing numbers until exposure of a layer of a basic material is practically more than 8000 times in a later mentioned testing method, and as to the surface skin, surface roughness RzD is less than 10 μm in the same.

In the above structure, desirably, the vulcanized material excepting the foaming agent of the compounded material of the foamed rubber shows tensile stress (JIS K 6251, M100) of 3 MPa or more. Rigidity of the rubber vulcanized material in the skin layer increases, and relatively, the demand to the abrasion resistance is easily satisfied.

It is desirable that the thermal decomposition typed foaming agent has average grain diameter being 8 μm or less, and is mixed in the compounded material of the foamed rubber in the form contained in a master batch of the raw rubber, or in the form carried in inorganic grains. With this structure, such a compounded material of the foamed rubber is ready for providing, which has the thickness of the skin layer and the bubble diameter satisfying the foaming agent good in dispersion, and the requirement of the invention.

Further, the compounded material of the foamed rubber is desirably based on a compounding preparation showing vulcanizing speed (JIS K 6300) (170° C., T₁₀) being 0.6 to 1.8 min. If the preparation is too slow in the vulcanizing speed, it is difficult to provide the bubble diameter under the predetermined value and the thickness of the skin layer above the predetermined value. If being too fast, scorching is soon, and storage stability is wanted.

Desirably, the compounded material of the foamed rubber is mixed with crystalline polyethylene (PE) of 5 to 50 mass parts for 100 mass parts of the raw rubber. If containing the crystalline PE, it is easy to obtain extruded products having a beautiful surface skin, that is, a small surface roughness.

It is desirable that the raw rubber is a blend of ethylenepropylene non-conjugate diene based rubber (EPDM) and ethylene-α-olefin non-conjugate diene based rubber (α-olefin carbon atoms: 4 to 8) (EODM), and the blend ratio is the former/the latter (mass ratio)=9/1 to 6/4. With this structure, the solid vulcanized material is easy to effect tensile stress (M100) being 5 MPa or more (compare Examples 3 and 4 with Examples 1 and 2). Namely, the extruded product of the foamed rubber excellent in the abrasion resistance is easily available.

Ordinarily, EODM is an ethylene butane non-conjugate diene based rubber.

The vulcanization for the extruded product of the foamed rubber of the invention is desirably carried out under conditions of average rate of heightening temperature until the vulcanizing temperature (180° C.) at 1.5 to 5° C./s. Setting the heightening temperature in the predetermined range, it is easy to secure the bubble diameter and thickness of the skin layer in numerical ranges according to the invention (compare Comparative example 1 and Example 1).

### BRIEF DESCRIPTION OF THE DRAWING

FIG. 1 is a cross sectional view of a glass run as one example of products to which the extruded product of the foamed rubber in the invention is applicable.

### DETAILED DESCRIPTION OF THE PREFERRED EMBODIMENTS

Explanation will be made to the extruded rubber product of the invention. So far as not especially specifying in the following description, the compounding units and the composition ratio are mass units.

(1) The extruded product of the foamed rubber (vulcanized material) of the invention has the ethylene-α-olefin based rubber as substantially the raw rubber, and is based on a premise of the extruded product of the foamed rubber prepared with the thermal decomposition typed foaming agent, and is characterized by the foaming magnification: 1.05 to 1.55, the bubble diameter: 110 μm or less, and the thickness of the skin layer: 130 μm or more.

In the above mentioned, preferable ranges are the foaming magnification: about 1.15 to 1.50, the bubble diameter: about 40 to 100 μm, and the thickness of the skin layer: about 150 to 350 μm, and more preferable ranges are the foaming magnification: about 1.15 to 1.30, the bubble diameter: about 50 to 95 μm, and the thickness of the skin layer: about 150 to 200 μm.

By determining the foaming magnification, the bubble diameter, and the thickness of the skin layer, in the abrasion resistance as mentioned above, the repetition of wearing numbers until a phase of a basic material appears is more than 8000 times, and as to the surface skin, the surface roughness RzD is less than 10 μm.

(2) As the ethylene-α-olefin based rubber being the raw rubber, ethylenepropylene non-conjugate diene terpolymer (EPDM) is suitably used, and such substances are also available where α-olefin having carbon atomes of 4 to 20 are substituted for all or parts of proplylene component. Ordinarily, ethylene amount is 55 to 75 wt %.

As the non-conjugate diene, favorably adopted are 5-ethylidyne-2-norbornane (ENB), dicyclopentadiene (DCPD), or 1,4-hexadiene (1,4-HD). The content of the non-conjugate diene is adjusted such that iodine value is 5 to 25.

As EPDM, a processing oil of 10 to 40 parts to 100 parts of the raw rubber (EPDM) may be used to an oil extended type added when producing polymer.

Further, it is sufficient to use polymer alloy type of the oil extended EPDM having in advance been blended with a later mentioned crystalline polyethylene (crystalline PE) 5 to 50 phr, desirably 10 to 40 phr, and more desirably 15 to 30 phr.

A desirable embodiment of the raw rubber is a blend of EPDM and ethylene-α-olefin non-conjugate diene based rubber other than EPDM (α-olefin carbon atoms: 4 to 8, desirably 4 to 5) (EODM), and the blend ratio is the former/the latter (mass ratio)=95/5 to 50/50. As EODM, ethylenebutene non-conjugate diene rubber (EBDM) is used.

At this time, although not necessarily, Mooney viscosity (JIS K 6300) Vm of the rubber compound is 45 to 65, desirably 50 to 60 from the viewpoint of the extrusion processability.

By blending EPDM and EODM, the skin layer, i.e., the tensile stress (M100) of the solid vulcanized material increases, and relative increase of the abrasion resistance may be expected (refer to Examples 3 and 4 to Examples 1 and 2 in Table 1).

If the viscosity of the compounded rubber is set in the above range, the bubble diameter easily goes down under the predetermined value.

(3) The solid vulcanized material excepting the foaming agent of the compounded material of the foamed rubber of the invention shows the tensile stress (JIS K 6251) M100: 3 MPa or higher, desirably 4 MPa or higher, and more desirably 5 MPa or higher. If the tensile stress (100% modulus: M100) is low, the abrasion resistance relatively decreases (refer to Examples 1 to 4 in Table 3). Incidentally, although not especially specifying an upper limit, it is applied to the upper limit (ordinarily, 200 phr) of CB compounding amount giving no influences to a kneading property/extrusion processability, and ordinarily 6 MPa or less, because the tensile stress is adjusted in dependence on the compounding amount of carbon black (CB)

(4) The thermal decomposition typed foaming agent of the invention is desirably mixed in the rubber compound at the under mentioned average grain diameter and in an embodiment, because dispersion of the foaming agent is good, and foams of the predetermined foaming magnification of small bubble diameter are easily obtained.

The average grain diameter is 8 μm or less, desirably 4 μm or less.

The compounding embodiments are in the form contained in the master batch of the raw rubber, or in the form carried in the inorganic grains.

The compounding amount of the foaming agent is varied depending on the required foaming magnification, the thickness of the skin layer, and sorts of the foaming agent, but ordinarily it is appropriately determined in ranges of 0.2 to 1.5 phr, desirably 0.3 to 1.0 phr. If the amount of the foaming agent is too much, it is difficult to obtain the thickness of the skin layer of more than predetermined values.

In case the thermal decomposition typed foaming agent is compounded in the form carried in the inorganic grains (inorganic carrier), a diameter of the inorganic grains is about 9 μm or less (desirably 0.1 to 7 μm, more desirably 0.1 to 2 μm). Herein, the foaming agent of the inorganic carrier may be mixed in the form of the master batch, but since the foaming agent of the inorganic carrier has a dispersing property in itself, it is not necessary to compound this foaming agent in the form of the master batch.

A reason for mixing as the foaming agent of the inorganic carrier is why dispersion of the foaming agent is uniformalized at the same time of making easy the specific gravity of the vulcanized material, that is, control of the foaming magnification, and why foaming degrees of respective parts are stabilized. The amount of containing the thermal decomposition typed foaming agent in the foaming agent of the inorganic carrier is ordinarily 2 to 50 wt %, desirably 5 to 25 wt %.

Further, even if the average diameter of the inorganic grain exceeds 9 μm and the average diameter of the thermal decomposition typed foaming agent exceeds 8 μm, it is difficult to provide “foaming magnification: 1.05 to 1.55, and the surface roughness RzD: 10 μm or less” as the characteristics of the invention in the vulcanized material of the foamed rubber, because a problem is easy to occur in the dispersion of the foaming agent.

If the diameter of the inorganic grain becomes large, the surface roughness trends to become large. A reason therefor is mainly assumed that an extruding resistance (extruding pressure) becomes relatively large. In case the average diameter of the thermal decomposition typed foaming agent becomes large, the surface roughness trends to become large. A reason therefor is assumed that a dispersing degree of the thermal decomposition typed foaming agent becomes relatively large.

Herein, as the inorganic grain, if the average diameter is 9 μm or less, no limitation is especially made. There may be listed inorganic fillers such as fine talc, light calcium carbonate, heavy calcium carbonate, magnesium carbonate, zinc oxide, wollastonite, silica, clay, talc, diatom earth, and those surface-treated with silane coupling agent. Talc having lubrication is desirable, and fine talc is especially desirable. As fine talc, those of average grain diameter of 0.1 to 1 μm, desirably 0.3 to 0.7 μm are served. In the case of the light calcium carbonate, those having average grain diameter of 0.2 to 4 μm, desirably 0.5 to 2 μm are served. In the case of the heavy calcium carbonate, those having average grain diameter of 0.5 to 9 μm, desirably 3 to 7 μm are served.

The foaming agents are varied depending on the vulcanizing temperatures and methods, and the under mentioned are usable.

There maybe listed 4,4′-oxybisbenzenesulfonylhydrazide (OBSH), azodicarbonamide (ADCA), dinitrosopentamethylenetetr amine (N,N′-DPT), p-toluensulfonylhydrazide (TSH), azobisiso butyronitrile (AZDN), and those used jointly with assistants.

Among them, those of thermally decomposing temperatures of 150 to 170° C. are desirable, and OBSH is typical.

The grain diameters of the inorganic grain and the thermal decomposition typed foaming agent are sufficient with those which will be finally under average grain diameter, and ordinarily, the respective average diameters are set to be under 8 μm (desirably, under 4 μm) at beginning of mixing. Because, in particular, the thermal decomposition typed foaming agent has the possibility of partial decomposition owing to shearing heat. In addition, the lower limits of the inorganic grains and the thermal decomposition typed foaming agent are not especially made, but, ordinarily from the viewpoint of handling and mixing properties, the lower limit of the inorganic grains is 0.1 μm, and that of the thermal decomposition typed foaming agent is 1 μM.

The preparing method of the foaming agent of the inorganic carrier normally depends on uniformalization of simple mixture by such as a super mixer. But, for more increasing uniformalizing degree of the foaming agent, the preparation may use a mechanical grain composition method (refer to an item of “Composition and Functional Technique of grain materials” at pages 27 to 33 of “Industrial Materials issued December 1993), otherwise may be adjusted by an emulsion suspending method using a liquidus reaction, a sol-gel process, a doping method, or a chemical vapor deposition (CVD).

As a specific example of the mechanical grain composition apparatus, an apparatus disclosed in JP-A-42728/88 is suitably used.

(5) The compounded material of the rubber according to the invention is based on a compounding preparation showing vulcanization speed (JIS K 6300) (17.0° C., T₁₀) of 0.6 to 1.8 min, desirably 0.8 to 1.4 min. The compound at the vulcanizing speed is adjusted by combination of general used vulcanization accelerator (refer to Tables 1 and 2). If the vulcanization speed is outside of the above range, it is difficult to effect the thickness of the skin layer and the bubble diameter of the predetermined values.

(6) The compounded material of the invention is mixed with crystalline polyethylene (PE) of 5 to 50 phr, desirably 10 to 40 phr, and more desirably 15 to 30 phr for 100 mass parts of EPDM.

By compounding the crystalline PE as the polymer component, the surface skin (surface roughness) can be by far improved in comparison with single EPDM. The reason therefor is assumed because the crystalline PE plasticized by extrusion is transferred to the surface side.

If the crystalline PE is too small, the improvement of the surface roughness RzD is less to exhibit, while being too much, low temperature resistance in the extruded product of the foamed rubber goes down.

(7) Next, the preparation of the rubber compound using the foaming agent of the inorganic carrier is carried out in the same manner as conventionally.

The rubber polymer is ordinarily compounded with secondary materials such as reinforcing filling agent (carbon black or white carbon), plasticizer, lubricant or vulcanized medicines other than the foaming agent of the inorganic carrier.

The compounded rubber is used to carry out the extruding formation by means of a rubber extruding machine, followed by vulcanization.

The extruding speed is then 8 to 25 m/min, desirably 12 to 18 m/min.

For vulcanization, it is sufficient to equip a microwave heating apparatus and a blast heating apparatus, or to furnish in succession two blast heating devices of different in temperature setting conditions, or further to interpose the microwave heating apparatus between the blast heating devices.

The vulcanizing condition is ordinarily 180 to 240° C.×2 to 10 min, desirably 210 to 230° C.×3 to 6 min.

### EXAMPLES

The invention will be more specifically explained by use of examples as follows.

<Preparation of Foamed/Solid Rubber Compounded Materials>

Depending on a close typed kneading machine and a roll kneading of a normal manner, and following the compounding preparations shown in Tables 1 and 2, the foamed/solid rubber compounded materials were kneaded and prepared. By the way, the solid rubber compounded material was prepared, adding no foaming agent in the foamed rubber compounded material.

The used raw rubbers and the foaming agents are as under.

(1) Raw Rubbers

EPDM (1) . . . ethylene containing amount: 62%,

iodine value: 12,

third component: ethylidennorbornane,

paraffine group: 10 phr,

PE: oil extending type of 20 phr addition

EPDM (2) . . . ethylene containing amount: 60%,

iodine value: 13.6,

third component: ethylidennorbornane,

paraffine group: 10 phr,

EPDM (3) . . . ethylene containing amount: 62%,

iodine value: 12,

third component: ethylidennorbornane,

paraffine group: 10 phr,

PP: oil extending type of 20 phr addition

EBDM . . . ML₍₁₊₄₎100° C.: 20

Density: 890 kg/cm³

iodine value: 22,

third component: ethylidennorbornane

(2) Foaming Agents

Foaming agent (1): 40% master batch of OBSH (4 μm)

Foaming agent (2): a mixture of OBSH (4 μm)+fine talc, of former/latter (mass ratio)=9/1, was thrown into a mixer (Super mixer: made by K.K. Kawata, capacity 10L), and mixed and prepared under conditions of 1440 rpm×4 min.

Foaming agent (3): microcapsule containing hydrocarbon of low point boiling

<Preparation of Foamed/Solid Rubber Extruded Products>

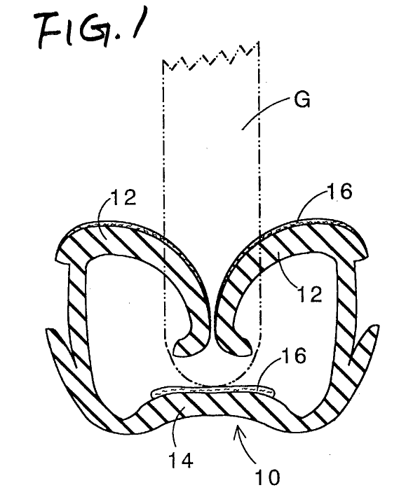

The respective foamed rubber compounded materials above prepared were extruded (condition: extrusion rate of 12 m/min) into glass runs (extruded product) having cross sectional shapes (thickness: 2 to 5 mm) as shown in FIG. 1 by means of the extruding machine (specification: cylinder diameter of 90 mmφ, L/D=22), and subsequently passed through UHF vulcanization (adjusting between 0.5 and 4 kW to be at rates of increasing temperatures as shown in the lowest row of Table 3) and the blast vulcanization (220° C.×4 min), and cut into the extruded products having length of 1 m to turn out respective test pieces (foamed rubber products).

The “rates of increasing temperatures” were demanded, immediately after extrusion, by measuring surface temperatures of the respective products at the exit of the UHF vulcanization chamber by means of a non-contacting typed temperature gage, and by dividing the surface temperatures with “transferring time” from immediately after extrusion to the exit of the UHF vulcanization chamber. The non-contacting typed temperature gage was “Long distance, Small spot handy temperature gage IT2-100” (made by Keense Inc.).

On the other hand, the solid rubber compounded materials above prepared were subjected to a press forming procedure (press forming (vulcanizing conditions: 170° C.×10 min, pressing pressure: 9.8 MPa)) to produce test pieces (160×150×2 mmt)

<Test Confirming Effects of the Invention>

As to the foamed/solid rubber compounded materials above produced and the vulcanized rubbers thereof, the under itemed tests were made.

(A) Physical Properties of Non-Vulcanized Rubbers

As to the foamed rubber compounded materials after above kneaded and prepared, the physical properties of the under itemed non-vulcanized rubbers were measured.

(1) Mooney viscosity . . . Rotor shape: L-shape, pre-heating time: 1 min., and testing temperature: 145° C. Under these conditions,

(2) Vulcanizing rate measured by “Curast meter WR type” (made by JSR Inc.) under the condition of 170° C.×12 min, following JIS K 6300.

(1) Foaming magnification . . . The magnification ratio of the specific gravity of the kneaded ground (foamed rubber compounded material) to the specific gravity of the above products (foamed vulcanized rubber). The specific gravity followed the underwater substitution method.

(2) Bubble diameter . . . Bubbles were enlarged through a microscope, and the bubbles of more than 50 were measured to ask for an average value.

(3) Thickness of the skin layer . . . Parts of more than 10 bubbles were enlarged through the microscope, and measured to ask for the average value.

(4) Surface roughness RzD . . . The surface roughness was measured with a surface roughness tester (“Surfcom 550A” made by Tokyo Precision (K.K.)).

(5) Abrasion resistance . . . The glass run main body 10 was formed on the bottom part 14 with the lubricant film (urethane coating material: polyesterpolyol group) 16 to be dried thicknes of about 20 μm, and an under mentioned glass abraser was reciprocally moved on the film 16 under the following conditions by use of an abrasion tester (abrasion tester for dye fastness test: JIS L 0823), and the reciprocally moving numbers were demanded until the basic material (bottom part 14) was exposed.

Glass abraser: 20 mm width (lower end R: 10 mm), and 4 mm thickness: (lower end R: 2 mm).

Abrasion conditions: 3 kg load, 140 mm reciprocating distance, and reciprocating speed of 60 reciprocation/min

(2) Physical Properties of Solid Vulcanized Rubber

Tensile stress (M100) . . . The tensile stress, when elongation (EB) was 100% in accordance with JIS K 6251, was measured.

<Tested Results>

From Table 3 showing the tested results, it is seen that the extruded products of the foamed rubbers in the respective examples showing the foaming magnification, the bubble diameter and the thickness of the skin layer falling in the numerical ranges of the invention, satisfy the requisite characteristics (surface roughness RzD of less than 10, and abrasion resistance of more than 8000 times).

Namely, the respective examples have the surface roughness equivalent to that of the solid rubber (reference example), and concurrently have the abrasion resistance than that of the solid rubber except the examples 3 and 4.

On the other hand, it is seen that the respective examples having either one of the bubble diameter and the skin layer thickness being outside of the numerical ranges of the invention, do not satisfy the characteristics of either one or both of the surface roughness RzD of less than 10 and the abrasion resistance of more than 8000 times.

That is, the comparative example 1 is delayed as to the average rate of increasing temperature in the same compounding preparation as in the example 1, and the skin layer becomes thicker while the bubble diameter exceeds the range of the invention. Accordingly, both of the abrasion resistance and the surface roughness do not satisfy the requisite characteristics.

The comparative example 2 shows the bubble diameter and the skin layer thickness being outside of the ranges of the invention, and does not satisfy the requisite characteristics of both of the abrasion resistance and the surface roughness.

The comparative example 3 show the skin layer thickness being outside of the range of the invention owing to use of microcapsule containing hydrocarbon of low boiling point, and does not satisfy the requisite characteristics of both of the abrasion resistance and the surface roughness.

The comparative example 4 shows the bubble diameter and the skin layer thickness being outside of the ranges of the invention, and does not satisfy the requisite characteristic of the abrasion resistance. The reason why the bubble diameter becomes large is assumed that since the dispersed polyolefin resin (PP) is non-compatible with EPDM, when the foaming agent is dissolved, the bubble diameter is easily increased at a portion of PP. On the other hand, since PE and EBDM in the examples are compatible with EPDM, the above problems as in PP do not occur.

In the above mentioned, to be the bubble diameter being less than 100 μm, if the vulcanizing speed is made fast as T₁₀ being less than 0.8 min, the storage stability of the compounded material is wanted.

TABLE 1

| | | Example 1 | Example 2 | Example 3 | Example 4 |
|---|---|---|---|---|---|
| Raw Rubbers | EPDM \mathring{1} | 110 | ← | 130 | ← |
| | EBDM | 15 | ← | | |
| FEF carbon black | | 185 | 195 | 190 | 185 |
| Paraffin based processing oil | | 85 | ← | ← | ← |
| Calcium carbonate | | 30 | ← | ← | ← |
| Active zinc oxide | | 3 | ← | ← | ← |
| Dehydrating agent (calcium oxide) | | 5 | ← | ← | ← |
| Processing aid | | 10 | ← | ← | ← |
| Vulcanizing agent (sulfur) | | 1.2 | ← | 1.5 | 1 |
| Vulcanization | Ditiocarbamic acid zinc group | 1 | ← | 1.5 | 0.5 |
| accelerator | Thiuram group | 0.5 | ← | ← | 0.4 |
| | Sulfaneamide group | 1 | ← | 1.5 | |
| | Thiazole group | | | | 1 |
| | Morpholine group | 1 | ← | ← | |
| | Thiourea group | | | | 0.2 |
| Foaming agent | \mathring{1} | 1.25 | 1.8 | 1.5 | 1.25 |
| (net amount) | | (0.5) | (0.72) | (0.6) | (0.5) |

| | | | | |
|---|---|---|---|---|
| Degree of vulcanization: 10%; | 1.3 | 1 | 0.8 | 1.0 |
| Time: T₁₀ (min) | | | | |
| Mooney viscosity Vm 145° C. | 56 | 55 | 51 | 55 |
| Total | 448.95 | 459.5 | 460.5 | 452.35 |

TABLE 2

| | | Com. ex. 1 | Com. ex. 2 | Com. ex. 3 | Com. ex. 4 | Re. ex. |
|---|---|---|---|---|---|---|
| Raw rubbers | EPDM \mathring{1} | Same as | 130 | 97.5 | | 130 |
| | EPDM \mathring{2} | Example 1 | | 27.5 | | |
| | EPDM \mathring{3} | | | | 119 | |
| | EBDM | | | | 15 | |
| FEF carbon black | | | 140 | ← | 185 | 170 |
| Paraffin based processing oil | | | 75 | 110 | 80 | ← |
| Calcium carbonate | | | 20 | | 30 | 35 |
| Stearic acid | | | 1 | ← | ← | |
| Active zinc oxide | | | 2 | ← | 3 | 3 |
| Dehydrating agent (calcium oxide) | | | 8 | 6 | 5 | ← |
| Processing aid | | | 25 | 2 | 10 | 10 |
| Vulcanizing agent (sulfur) | | | 2 | 1.5 | ← | 0.8 |
| Vulcanization | Ditiocarbamic acid zinc | | 2 | 1.2 | 3 | 0.5 |
| accelerator | group | | | | | |
| | Thiuram group | | 0.5 | 0.3 | | 0.4 |
| | Sulfaneamide group | | | 1 | | |
| | Thiazole group | | 2 | | 2.5 | 1 |
| | Morpholine group | | | | 1 | |
| | Thiourea group | | 0.5 | | 0.5 | 0.1 |
| Foaming agent, | \mathring{1} | | | | 1.25 (0.5) | |
| net amount within ( ) | \mathring{2} | | 1.5 (0.15) | | | |
| | \mathring{3} | | | 5 | | |

| | | | | |
|---|---|---|---|---|
| Degree of vulcanization: 10%; | 0.7 | 1.0 | 0.6 | 1.3 |
| Time: T₁₀ (min) | | | | |
| Mooney viscosity Vm 145° C. | 43 | 51 | 52 | 54 |
| Total | 409.5 | 396.0 | 456.75 | 438.8 |

Com. ex.: Comparative example
Re. ex.: Reference example

TABLE 3

| | Example | | | | Comparative example | | | | Roughness in surface RzD |
|---|---|---|---|---|---|---|---|---|---|
| | 1 | 2 | 3 | 4 | 1 | 2 | 3 | 4 | (μm) |
| Foaming magnification | 1.2 | 1.5 | 1.4 | 1.2 | 1.3 | 1.2 | 1.1 | 1.2 | |
| (times) | | | | | | | | | |
| Diameter of foam (μm) | 83 | 91 | 52 | 85 | 194 | 120 | 40 | 136 | |
| Skin layer (μm) | 180 | 163 | 155 | 180 | 300 | 80 | 10 | 92 | |
| Pressed sheet M100 (MPa) | 5.3 | 5.5 | 4.4 | 3 | 5.3 | 3 | 4.2 | 5.7 | 3.9 |
| Abrasion resistance | 16000 | 14000 | 12000 | 10000 | 4000 | 3000 | 2500 | 4000 | 14000 |
| (3 kgf) NG number | | | | | | | | | |
| Roughness in surface RzD | 6 | 7 | 7 | 7 | 11 | 12 | 15 | 9 | 7 |
| (μm) | | | | | | | | | |
| Temperature increasing | 3.0 | 2.7 | 3.6 | 3.1 | 1 | 2.9 | 3 | 2.8 | 3.4 |
| rate (° C./sec) | | | | | | | | | |
| until 180° C. | | | | | | | | | |

What is claimed is:

1. An extruded product of a foamed rubber (vulcanized material) wherein an ethylene-α-olefin based rubber is substantially a raw rubber, and extruded from a compounded material of a foamed rubber prepared with a thermal decomposition typed foaming agent,
in which,
foaming magnification is 1.05 to 1.55,
bubble diameter is 110 μm or less, and
thickness of skin layer is 130 μm or more.

2. The extruded product of the foamed rubber as set forth in claim 1 wherein a solid vulcanized material excepting the foaming agent of the compounded material of the foamed rubber shows tensile stress (JIS K 6251, M100) of 3 MPa or more.

3. The extruded product of the foamed rubber as set forth in claim 1 wherein the thermal decomposition typed foaming agent has average grain diameter of 8 μm or less, and said thermal decomposition typed foaming agent is mixed in said compounded material of the foamed rubber in the form contained in a master batch of the raw rubber, or in the form carried in inorganic grains.

4. The extruded product of the foamed rubber as set forth in claim 1 wherein the compounded material of the foamed rubber is of a compounding preparation showing vulcanization speed (JIS K 6300) (170° C., T₁₀) 0.6 to 1.8 min.

5. The extruded product of the foamed rubber as set forth in claim 1 wherein the compounded material of the foamed rubber is mixed with crystalline polyethylene (PE) of 5 to 50 mass parts for 100 mass parts of the raw rubber.

6. The extruded product of the foamed rubber as set forth in claim 1 wherein the raw rubber is a blend of ethylenepropylene non-conjugate diene based rubber and ethylene-α-olefin non-conjugate diene based rubber (α-olefin carbon atoms: 4 to 8), and the blend ratio is the former/the latter (mass ratio) 9/1 to 6/4.

7. The extruded product of the foamed rubber as set forth in claim 6 wherein the ethylene-α-olefin non-conjugate diene based rubber is an ethylenebutene non-conjugate diene based rubber.

8. A method of producing the extruded product of the foamed rubber as set forth in claim 1, wherein the vulcanization of the extruded product of the foamed rubber is carried out under conditions of average rate of heightening temperature until the vulcanizing temperature (180° C.) at 1.5 to 5° C./s.
